(19) United States
(12) Patent Application Publication
(10) Pub. No.: US 2004/0265414 A1
(43) Pub. Date: Dec. 30, 2004

(54) Extrusion molding system and method

(75) Inventor: Takayuki Kobayashi, Chiba (JP)

Correspondence Address: FOLEY AND LARDNER, SUITE 500, 3000 K STREET NW, WASHINGTON, DC, 20007, US

(73) Assignee: KINUGAWA RUBBER IND. CO., LTD.

(21) Appl. No.: 10/854,798

(22) Filed: May 27, 2004

(30) Foreign Application Priority Data
May 28, 2003 (JP) 2003-150021

(51) Int. Cl. B29C 47/22

(52) U.S. Cl. 425/378.1; 425/465; 425/466

(57) ABSTRACT

An extrusion molding system includes a movable die arranged at an output end of an extruder to be movable in an optional direction, a cooling water tank arranged to extend linearly from an outlet of the movable die, and a plurality of restrictors arranged in series in the cooling water tank to be moveable in an optional direction. Each restrictor has a passage formed therethrough to restricted the passing position and direction of a work by passing the work through the passage.

### BACKGROUND OF THE INVENTION

The present invention relates to an extrusion molding system and method of manufacturing an extrusion having cambered shape.

Typically, vehicular parts such as a door molding have a metallic core material, such as stainless steel, aluminum or the like, embedded therein. Thus, in order to provide a camber, the vehicular parts should be subjected to bending, for example, by a stretch bender after extrusion.

Recently, in terms of weight reduction and recycling-ability, the vehicular parts are often made of thermoplastic hard or soft resin having no metallic core material. Thermoplastic resin can be bent by reheating after extrusion, which brings, however, an increase in manufacturing cost due to increased number of manufacturing processes. Particularly, when made of thermoplastic hard resin, the vehicular parts have a drawback of poor following-ability about bending.

The cambered shape is provided to an extrusion, for example, by using a system comprising various devices arranged on a circular section. Specifically, the system comprises an extruder for extruding heated thermoplastic resin, a die fixed to an output end of the extruder, a cooling water tank having therein sizers for restricting the position of a work, and a drawer/cutter for drawing/cutting an extrusion, which are arranged on the same circumference in order.

Melted resin is discharged from the extruder to the sizers. While passing a work of melted resin through the sizers, it is cooled down by the cooling water tank, obtaining a product or extrusion of optional cambered shape.

### SUMMARY OF THE INVENTION

When adopting the above system, however, only a camber of given curvature is obtained, which renders achievement of the product shape with continuously varying curvature impossible.

Further, a production line should be set to correspond to the curvature of a work. That is, various devices, such as an extruder, cooling water tank, adhesive application vessel and the like, required to extrusion molding should be arranged or shaped curvedly, or should be made with increased width and height, leading to considerable increase in required area and manufacturing cost of the devices. Moreover, the layout of the devices or the devices themselves should be changed in accordance with the cambered shape of products.

Furthermore, since a work is not fed linearly, but circumferentially, a drive for feeding a work should be arranged at the midpoint of the production line in addition to arrangement of a guide roller for restricting the work position along the production line and a drawer at the end thereof, leading to complicated process and system.

It is, therefore, an object of the present invention to provide an extrusion molding system and method of manufacturing an extrusion having cambered shape, which allow not only achievement of the product shape with either given curvature or continuously varying curvature during an extrusion process only, but also restrained number and required area of component devices.

The present invention provides generally a system for molding an extrusion, which comprises: an extruder which extrudes a melted resin; a die arranged at an output end of the extruder to be movable in an optional direction, the die having a passage formed therethrough, the die discharging the melted resin through the passage; a tank arranged to extend linearly from an outlet of the die, the tank serving to cool down a work of the melted resin; and a plurality of restrictors arranged in series in the tank to be movable in an optional direction, each restrictor having a passage formed therethrough, each restrictor restricting a passing position and direction of the work by passing the work through the passage.

An essential feature of the present invention lies in providing a method of molding an extrusion, the extrusion being obtained by passing a work of melted resin extruded from an extruder through a die and inside passages of restrictors, wherein the method comprises: arranging the die and the restrictors on a substantially straight line; and controlling positions of the die and the restrictors so that a shape of the inside passages of the die and restrictors connected in series successively corresponds to a shape of the extrusion.

### BRIEF DESCRIPTION OF THE DRAWINGS

The other objects and features of the present invention will become apparent from the following description with reference to the accompanying drawings, wherein:

FIGS. 1A-1C are schematic views for explaining a method of making a work roughly linear, wherein FIG. 1A shows method applied to an extrusion of small curvature, FIG. 1B shows method applied an extrusion of large curvature, and FIG. 1C shows method applied to an extrusion of continuously varying curvature;

FIG. 2 is a block diagram showing layout of a first embodiment of an extrusion molding system;

FIG. 3 is a perspective view showing the extrusion molding system with a movable die and movable sizers located in a reference position;

FIG. 4 is a view similar to FIG. 3, showing the extrusion molding system when movement of the movable die and movable sizers is controlled;

FIG. 5 is a view similar to FIG. 1A, for explaining control of the movable die and movable sizers at start of driving in the first embodiment;

FIG. 6 is a view similar to FIG. 5, for explaining control of the movable die and movable sizers at continuous driving in the first embodiment;

FIG. 7 is a view similar to FIG. 6, for explaining control of the movable die and movable sizers at start of driving in a second embodiment of the present invention; and

FIG. 8 is a view similar to FIG. 7, for explaining control of the movable die and movable sizers at continuous driving in the second embodiment.

### DETAILED DESCRIPTION OF THE INVENTION

Referring to the drawings, a description is made about preferred embodiments of an extrusion molding system and method of manufacturing an extrusion having cambered shape. In the embodiments, extrusion molding is carried out by roughly linearly setting the shape of a work.

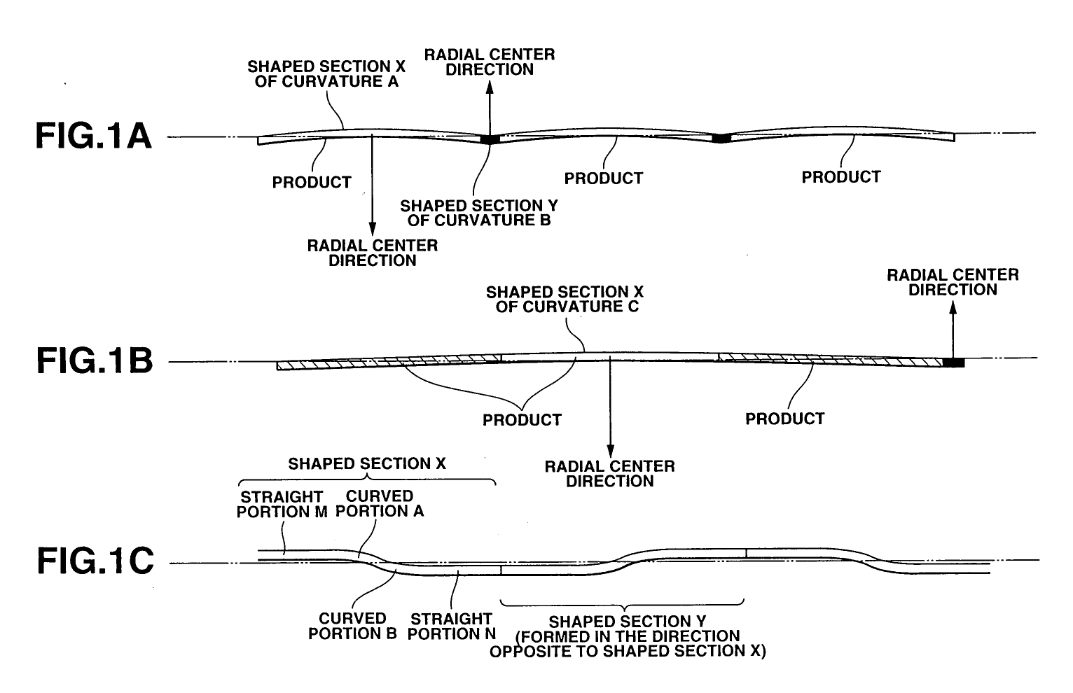

Specifically, referring FIGS. 1A and 1B, when manufacturing an extrusion having cambered shape of a given curvature A, a shaped section X (first shaped section) of curvature A having length of a product and a shaped section Y (second shaped section) of curvature B having radial center in the direction opposite to the radial center of curvature A are connected to each other alternately continuously as shown in FIG. 1A, or a shaped section X (first shaped section) of curvature C having length equal to an integral multiple of the length of a product and a shaped section Y (second shaped section) of curvature D having radial center in the direction opposite to the radial center of curvature C are connected to each other alternately continuously as shown in FIG. 1B.

Referring to FIG. 1C, when manufacturing an extrusion having cambered shape of a continuously varying curvature, a shaped section X (third shaped section) including curved portions A, B of different curvatures and straight portions M, N and a shaped section Y (fourth shaped section) including the same curved portions and straight portions as those of the shaped section X are connected symmetrically repeatedly.

Optionally, the shaped sections X, Y may be replaced with the curved portions A, B.

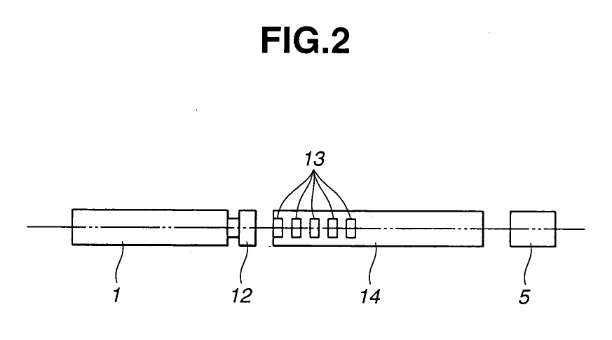

By configuring the shaped sections X, Y as shown in FIGS. 1A-1C to make the shape of a work roughly linear, a series of devices of the extrusion molding system, such as an extruder 1, a movable die 12, movable sizers 13 and a drawer/cutter 5, can be arranged linearly as shown in FIG. 2.

Referring to FIG. 2, the extruder 1 serves to extrude heated thermoplastic resin. The movable die 12 is arranged at the front end of the extruder 1 to be movable and rotatable in an optional direction. The movable die 12 serves to discharge melted resin through an inside passage, providing the sectional shape to an extrusion (work).

The movable sizers (restrictors) 13 are arranged in series at predetermined intervals on a straight line along the resin discharge direction of the movable die 12. The movable sizers 13 are disposed in the cooling water tank 14 configured longitudinally linearly to be movable and rotatable in an optional direction. The movable sizers 13 serve to restrict the passing position and direction of a work of melted resin fed from the movable die 12 by passing the work through the inside passage.

The movable die 12 arranged at the front end of the extruder 1, the movable sizers 13 in the cooling water tank 14, and the drawer/cutter 5 are arranged on the same straight line in order.

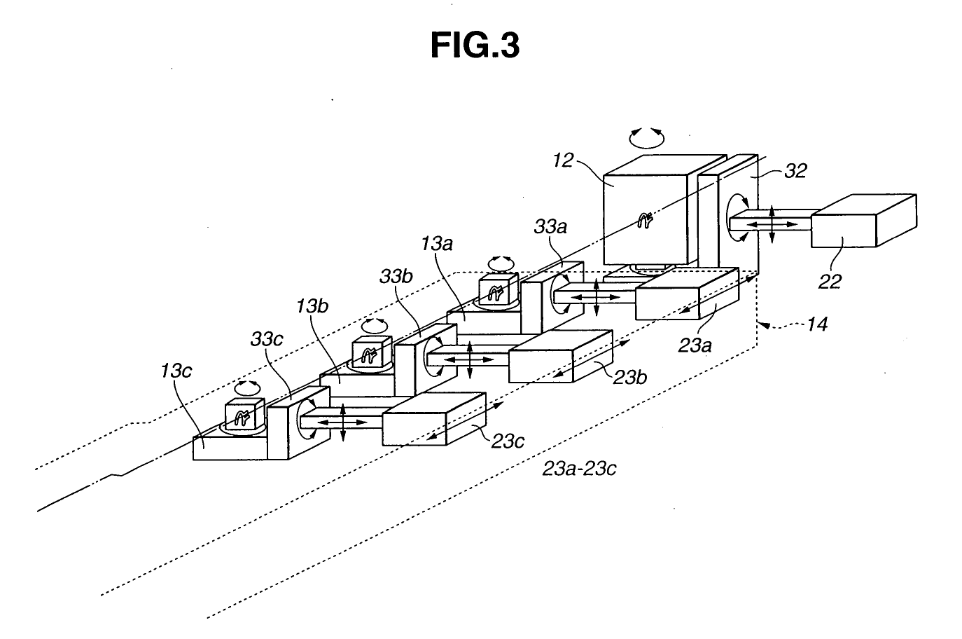

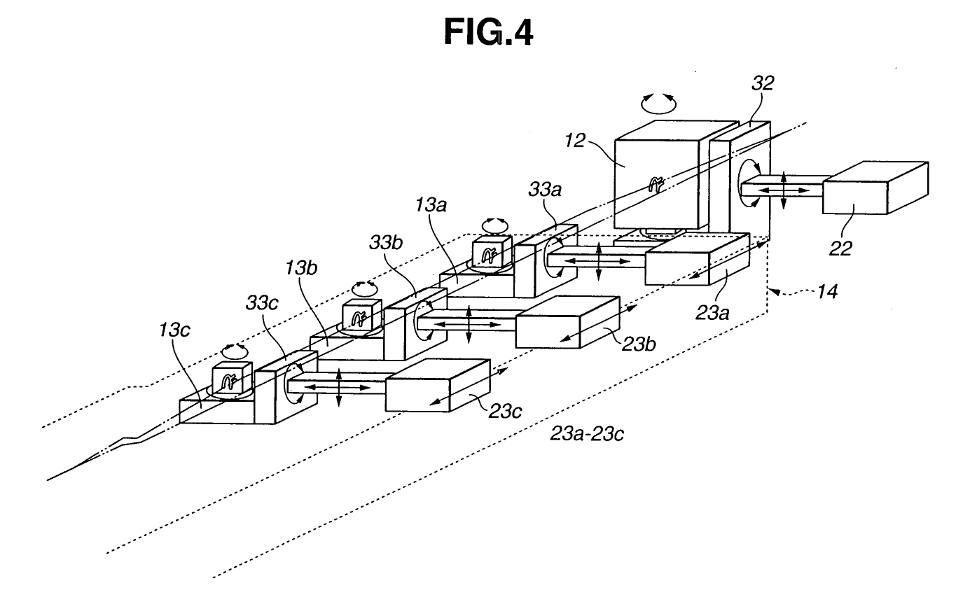

Referring to FIGS. 3 and 4, there are arranged driving means or device for moving and rotating the movable die 12 and the movable sizers 13 in an optional direction. It is noted that FIGS. 3 and 4 show only three movable sizers 13a-13c. FIG. 3 shows a state that the movable die 12 and the movable sizers 13 are arranged on a straight line, whereas FIG. 4 shows a state that the movable die 12 and the movable sizers 13 are moved in one direction orthogonal to the work feed direction.

A die driving actuator 22 is arranged to move the movable die 12 in the width and height directions of the cooling water tank 14 and rotate it in an optional direction.

The movable die 12 is mounted to a block 32 including two plates formed like a letter L. Movement and rotation of the movable die 12 are controlled through operation of a driving shaft of the die driving actuator 22 to the block 32.

A mechanism, not shown, is arranged in the block 32 to transmit a driving force of the driving shaft of the die driving actuator 22 to the movable die 12.

Sizer driving actuators 23a-23c are arranged to move the movable sizers 13a-13c in the length, width and height directions of the cooling water tank 14 and rotate them in an optional direction.

The movable sizers 13a-13c are mounted to blocks 33a-33c each including two plates formed like a letter L. Movement and rotation of the movable sizers 13a-13c are controlled through operation of driving shafts of the sizer driving actuators 23a-23c to the blocks 33a-33c.

A mechanism, not shown, is arranged in the block 33a-33c to transmit a driving force of the driving shaft of the sizer driving actuator 23a-23c to the movable sizer 13a-13c.

The structure shown in FIGS. 3 and 4 allows the movable die 12 to be controlled in movement and rotation, and the movable sizers 13a-13c to be controlled in movement and rotation so that the shape of a work passing through the movable sizers 13a-13c in the cooling water tank 14 configured linearly in the length direction corresponds to the shape of the shaped sections X, Y having curvatures and curved portions as shown in FIGS. 1A-1C.

Under sequence control, for example, the movable die 12 and the movable sizers 13 are driven successively so that a work is in a given coordinate position and angle. While doing so, the work is cooled down, obtaining an extrusion of optional curvature.

The depth dimension (length from the inlet to the outlet) of the movable sizer 13 is preferably shorter, since the movable sizer 13 cannot accommodate a camber of a work to interfere therewith if the depth dimension is too long. In the first embodiment, therefore, the depth dimension of the movable sizer 13 is set to a small value at which the movable sizer 13 can accommodate the bent shape of an extrusion.

In the first embodiment, the section of the movable sizer 13 is shaped straightly. Optionally, the section may be shaped sectorially to have the dimension of the inlet and outlet increased. Such sectorial shape of the movable sizer 13 allows a work to be prevented from interfering with the movable sizer 13.

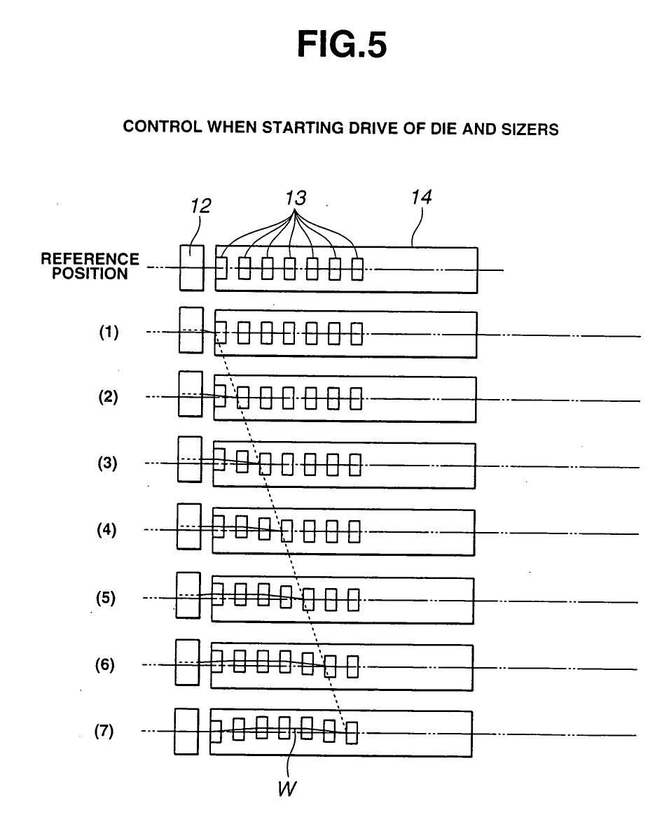

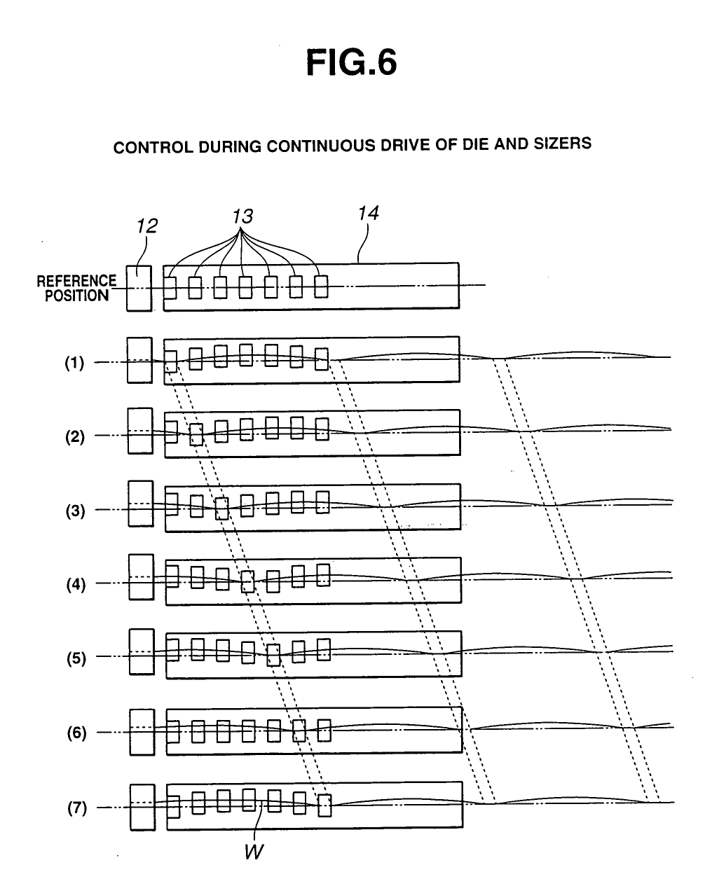

Referring to FIGS. 5 and 6, a detailed description is made about a method of continuously shaping an extrusion of curvatures A, B as shown in FIG. 1A. FIGS. 5 and 6 show a change in coordinate position of the movable die 12 and the movable sizers 13. In the first embodiment, the angles of the movable die 12 and the movable sizers 13 are not changed.

Referring to FIG. 5, when starting drive of the movable die 12 and the movable sizers 13, the position of the movable sizers 13 is changed continuously from the reference position to positions (1)-(7), shaping a work W of curvatures A, B. Then, referring to FIG. 6, in the similar way, the position of the movable sizers 13 is changed continuously from the reference position to positions (1)-(7), obtaining a roughly linear extrusion.

The curvature is determined by cooling down the work W with the passing position and incoming direction restricted by the position between three points and angle of adjacent movable die 12 and movable sizers 13.

Referring to FIG. 1A, at a cutting process, a shaped work is cut at a boundary of the shaped section X which becomes a product and the shaped section Y which does not become a product, obtaining a final extrusion of given curvature A.

The shaped section Y to be separated from an extrusion or product is preferably as short as possible. However, when the shaped section Y is too short, the rate of change becomes great in a section where the curvature is changed from curvature A → curvature B → curvature A. Thus, a work interferes intensely with the movable sizers 13 to have higher possibility of being caught thereat, requiring a large clearance between the work and the movable sizers 13. However, when the clearance is too large, the shape accuracy of an extrusion is lowered. On that account, the length and curvature of the shaped section Y are set preferably at appropriate values, respectively, in view of the target curvature and sectional accuracy of the product shape.

Referring to FIG. 1B, reducing the shaped section Y which does not become a product can be achieved by setting the length of the shaped section X at a value equal to a multiple of the length of a product, and thus increasing the number of products which can be taken per cycle.

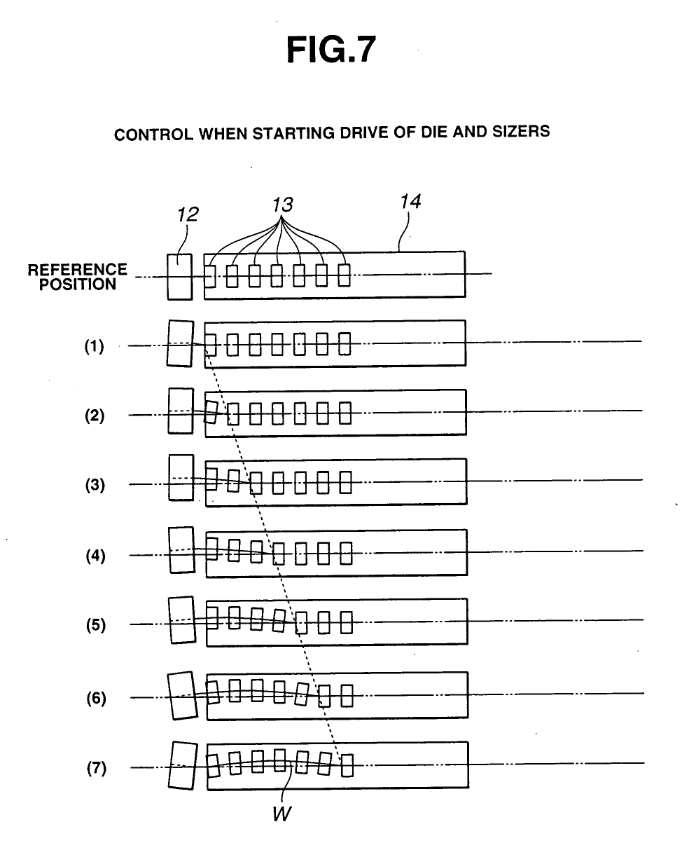

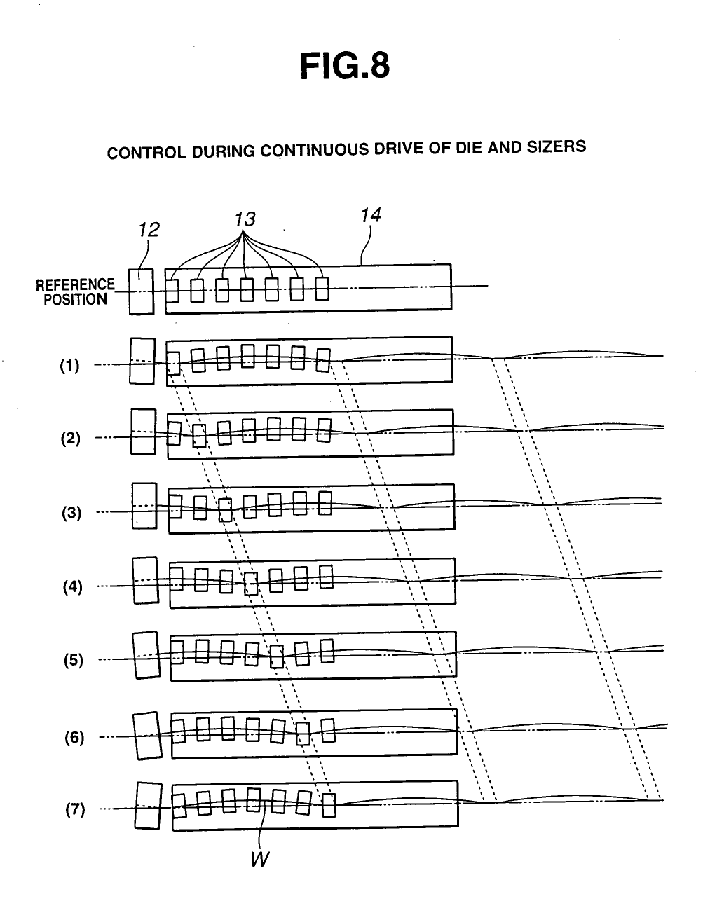

Referring to FIGS. 7 and 8, a detailed description is made about a method of continuously shaping an extrusion of continuously varying curvature as shown in FIG. 1C. FIGS. 7 and 8 show a change in coordinate position and angle of the movable die 12 and the movable sizers 13.

Referring to FIG. 7, when starting drive of the movable die 12 and the movable sizers 13, the position and angle of the movable sizers 13 are changed continuously from the reference position to positions (1)-(7), shaping work W including shaped sections of continuously varying curvature connected symmetrically. Then, referring to FIG. 8, in the similar way, the position and angle of the movable sizers 13 are changed continuously from the reference position to positions (1)-(7), obtaining a roughly linear extrusion. In the similar way as described above, a final extrusion of continuously varying curvature is obtained through the cutting process.

In the embodiments, the driving means for moving and rotating the movable die 12 and the movable sizers 13 are configured as shown in FIGS. 3 and 4. Alternatively, the driving means may be configured otherwise.

As described above, according to the inventions described in claims 1-15, an extrusion having cambered shape can be obtained by in-line working in an extrusion molding process without requiring bending at secondary working, resulting in a reduction in working cost.

Further, a product of continuously varying curvature and a product of complicated shape comprising straight and curved portions can be obtained easily, resulting in an improvement in forming flexibility and function/performance of the product.

Furthermore, a work is formed substantially linearly, resulting in restrained required area of the system and no need of a special-purpose apparatus for carrying a work, such as a feeder, for example. Moreover, an optional cambered shape can be obtained without changing system layout, leading to an improvement in productivity.

According to the inventions described in claims 2 and 11, it allows easy achievement of a product of smaller curvature and a product of continuously varying curvature having greater rate of change, i.e. greater curvature difference.

According to the invention described in claim 3, a work is prevented from being caught at the restrictor by interfering therewith.

According to the invention described in claim 5, a clearance between a work and the restrictor is greater at the inlet and outlet of the inside passage of the restrictor, allowing prevention of interference of the work with the restrictor.

According to the inventions described in claims 7 and 12, the work comprises a first shaped section and a second shaped section having radial center in the direction opposite to radial center of the first shaped section and connected to the first shaped section, allowing sure achievement of substantially linear work.

According to the inventions described in claims 8 and 13, it allows not only sure achievement of substantially linear work, but also increase in number of first shaped sections which can be taken per cycle and decrease in number of second shaped sections which do not become a product, i.e. enhancement in production efficiency.

According to the invention described in claims 9 and 14, the work comprises third and fourth shaped sections of a continuously varying curvature connected to provide a symmetry, allowing sure achievement of substantially linear work.

Having described the present invention in connection with the preferred embodiments, it is noted that the present invention is not limited thereto, and various changed and modifications can be made without departing from the scope of the present invention.

The entire teaching of Japanese Patent Application P2003-150021 field May 28, 2003 are hereby incorporated by reference.

What is claimed is:

1. A system for molding an extrusion, comprising:
an extruder which extrudes a melted resin;
a die arranged at an output end of the extruder to be movable in an optional direction, the die having a passage formed therethrough, the die discharging the melted resin through the passage;
a tank arranged to extend linearly from an outlet of the die, the tank serving to cool down a work of the melted resin; and
a plurality of restrictors arranged in series in the tank to be movable in an optional direction, each restrictor having a passage formed therethrough, each restrictor restricting a passing position and direction of the work by passing the work through the passage.

2. The system as claimed in claim 1, wherein the die and the restrictors are arranged to be rotatable in optional directions, respectively.

3. The system as claimed in claim 1, wherein the passage of each restrictor is of a length which can accommodate a bent shape of the work, the length being an extent from an inlet of the passage to an outlet thereof.

4. The system as claimed in claim 3, wherein the passage of each restrictor is of an inner diameter having the same value throughout the length of the passage.

5. The system as claimed in claim 3, wherein the passage of each restrictor is of an inner diameter having a greater value at the inlet and the outlet of the passage than at other longitudinal portions of the passage.

6. The system as claimed in claim 1, further comprising:
a driving device which moves and rotate the die and the restrictors in an optional direction.

7. The system as claimed in claim 1, wherein the work comprises a first shaped section of a first curvature and a second shaped section of a second curvature and having a radial center in a direction opposite to a radial center of the first shaped section, the first and second shaped sections being connected alternately substantially linearly.

8. The system as claimed in claim 7, wherein the first shaped section comprises a plurality of shaped portions of the first curvature connected in series substantially linearly.

9. The system as claimed in claim 7, wherein the work comprises a third shaped section of a continuously varying curvature and a fourth shaped section of the same curvature as that of the third shaped section, the third shaped section and the fourth shaped section being connected alternately substantially linearly to provide a symmetry.

10. A method of molding an extrusion, the extrusion being obtained by passing a work of melted resin extruded from an extruder through inside passages of a die and restrictors, the method comprising:
arranging the die and the restrictors on a substantially straight line; and
controlling positions of the die and the restrictors so that a shape of the inside passages of the die and restrictors connected in series successively corresponds to a shape of the extrusion.

11. The method as claimed in claim 10, further comprising:
controlling angles of the die and the restrictors.

12. The method as claimed in claim 10, wherein the work comprises a first shaped section of a first curvature and a second shaped section of a second curvature and having a radial center in a direction opposite to a radial center of the first shaped section, the first and second shaped sections being connected alternately substantially linearly.

13. The method as claimed in claim 12, wherein the first shaped section comprises a plurality of shaped portions of the first curvature connected in series substantially linearly.

14. The method as claimed in claim 12, wherein the work comprises a third shaped section of a continuously varying curvature and a fourth shaped section of the same curvature as that of the third shaped section, the third shaped section and the fourth shaped section being connected alternately substantially linearly to provide a symmetry.

15. A system for molding an extrusion, comprising:
an extruder which extrudes a melted resin;
a die arranged at an output end of the extruder to be movable in an optional direction, the die discharging the melted resin;
a tank arranged to extend linearly from an outlet of the die, the tank serving to cool down a work of the melted resin; and
means, arranged in series in the tank to be movable in an optional direction and having a passage formed therethrough, for restricting a passing position and direction of the work by passing the work through the passage.
